(19) United States
(12) Patent Application Publication
(10) Pub. No.: US 2017/0139600 A1
(43) Pub. Date: May 18, 2017

(54) DATA STORAGE DEVICE AND DATA MAINTENANCE METHOD THEREOF

(71) Applicant: Silicon Motion, Inc., Jhubei City (TW)

(72) Inventor: Kuan-Yu KE, Zhubei City (TW)

(21) Appl. No.: 15/331,116

(22) Filed: Oct. 21, 2016

(30) Foreign Application Priority Data
Nov. 18, 2015 (TW) 104138019

(51) Int. Cl. G06F 3/06; G06F 12/1009

(52) U.S. Cl. CPC G06F 3/064; G06F 3/0604; G06F 3/0679; G06F 12/1009; G06F 2212/7201

(57) ABSTRACT

The present invention provides a data storage device including a flash memory and a controller. The flash memory includes a plurality of blocks. Each of the blocks has a plurality of pages. The flash memory stores data of a plurality of logical addresses. The controller reads a first current block and a second current block from the flash memory in sequence to build a first current block table and a second current block table and builds a bit table according to the logical addresses of the pages of the second current block when the data storage device is resumed from a power-off state, wherein the controller further organizes the first current block table and the second current block table according to the bit table.

### CROSS REFERENCE TO RELATED APPLICATIONS

This application claims priority of Taiwan Patent Application No. 104138019, filed on Nov. 18, 2015, the entirety of which is incorporated by reference herein.

### BACKGROUND OF THE INVENTION

Field of the Invention

The present invention is related to a data storage device, and in particular it is related to a data storage device capable of maintaining data using a bit table.

Description of the Related Art

Flash memory is considered a non-volatile data-storage device, using electrical methods to erase and program itself. NAND Flash, for example, is often used in memory cards, USB flash devices, solid state devices, eMMCs, and other memory devices.

Flash memory such as NAND Flash uses a multiple-block structure to store data, wherein the flash memory uses floating gate transistors. The floating gates of the floating gate transistor may catch electronic charges for storing data. Moreover, the mapping relationships of the physical pages of the flash memory and the logical page assigned by the controller are recorded by a mapping table. When the power unexpectedly turns off, the mapping table stored in the random access memory will be lost. Therefore, it is important to efficiently rebuild the mapping table while the flash memory is resumed.

### BRIEF SUMMARY OF THE INVENTION

A detailed description is given in the following embodiments with reference to the accompanying drawings.

An exemplary embodiment provides a data storage device including a flash memory and a controller. The flash memory includes a plurality of blocks. Each of the blocks has a plurality of pages. The flash memory stores data of a plurality of logical addresses. The controller reads a first current block and a second current block from the flash memory in sequence to build a first current block table and a second current block table and builds a bit table according to the logical addresses of the pages of the second current block when the data storage device is resumed from a power-off state, wherein the controller further organizes the first current block table and the second current block table according to the bit table.

Another exemplary embodiment provides a data maintenance method applied to a data storage device of a flash memory. The flash memory includes a plurality of blocks, each of the blocks includes a plurality of page, and the flash memory stores data of a plurality of logical addresses. The data maintenance method includes: reading a first current block and a second current block from the flash memory in sequence to build a first current block table and a second current block table and building a bit table according to the logical addresses of the pages of the second current block when the data storage device is resumed from a power-off state; and organizing the first current block table and the second current block table according to the bit table.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an electronic system, constructed in accordance with an embodiment.

FIG. 2 is a schematic diagram illustrating a flash memory, constructed in accordance with an embodiment.

FIG. 3 is a schematic diagram illustrating a current block, constructed in accordance with an embodiment.

FIG. 4 is a schematic diagram illustrating a current block table and a bit table, constructed in accordance with an embodiment.

FIG. 5 is a flowchart of a data maintenance method constructed in accordance with some embodiments.

FIG. 6 is a flowchart of a method for organizing a current block table constructed in accordance with some embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

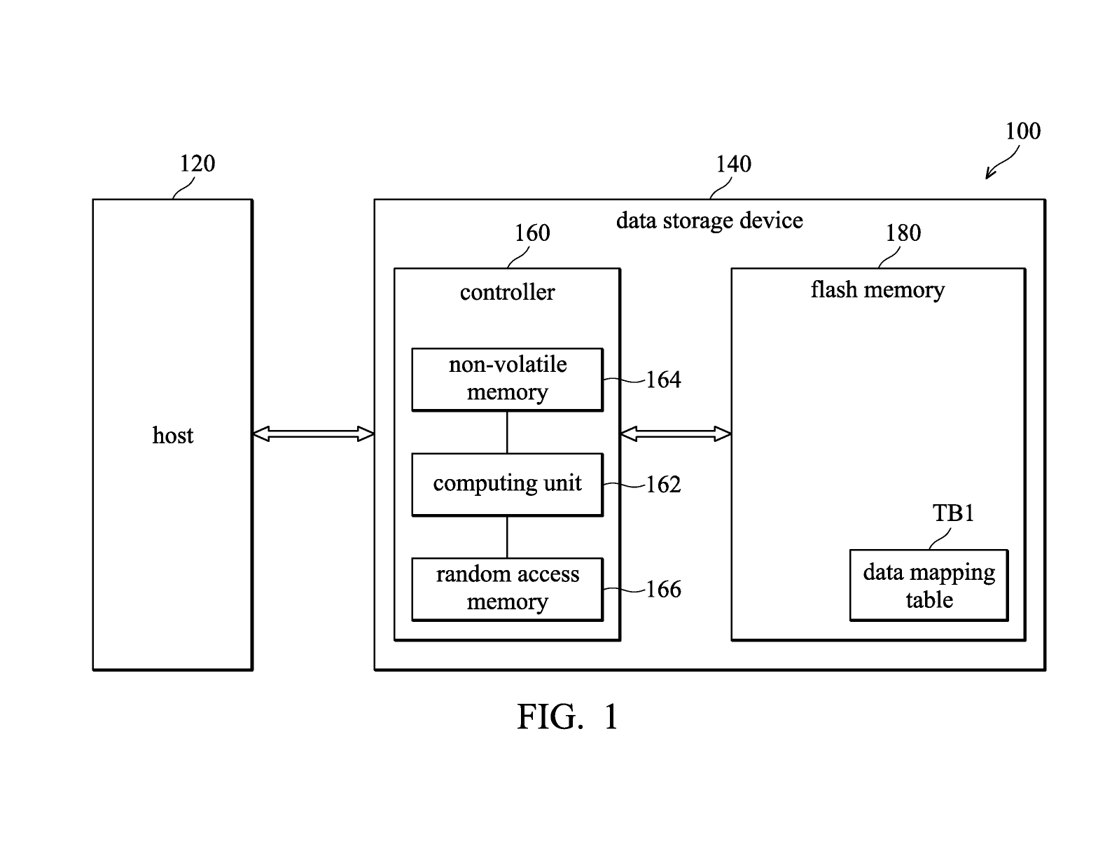

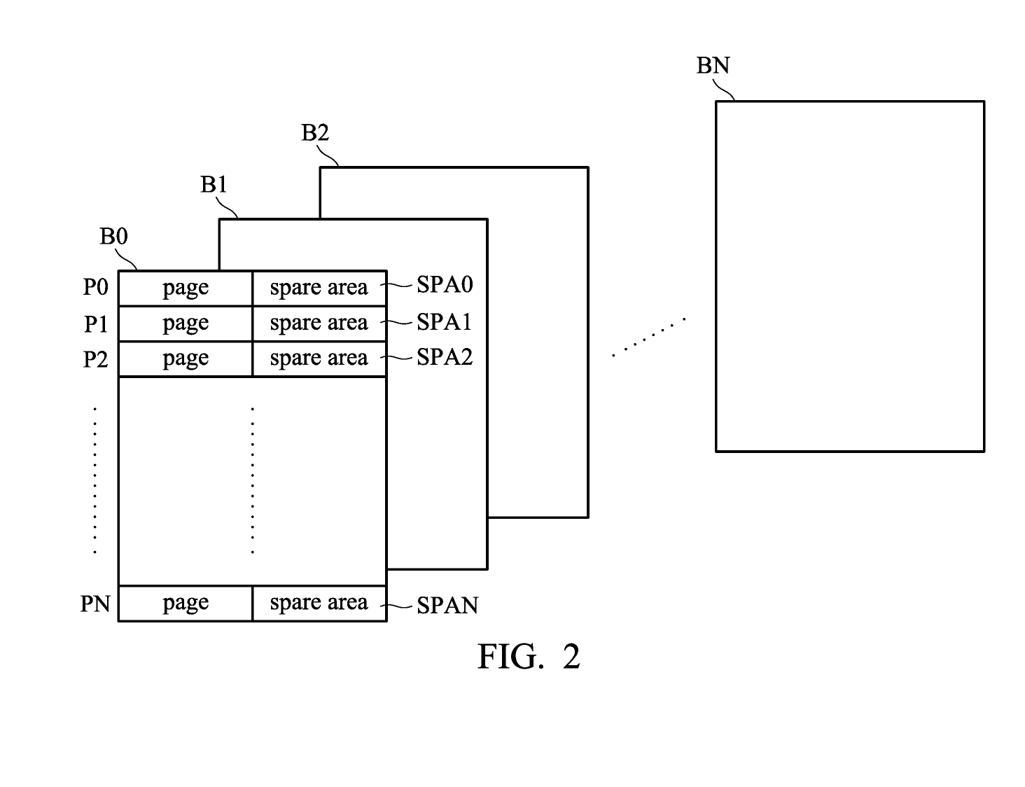

FIG. 1 is a schematic diagram illustrating an electronic system, constructed in accordance with an embodiment. The electronic system 100 includes a host 120 and a data storage device 140. The data storage device 140 includes a flash memory 180 and a controller 160, and operates in response to the commands of the host 120. The controller 160 includes a computing unit 162, a non-volatile memory 164 (ROM) and a random access memory 166 (RAM). The non-volatile memory 164, the program code stored in the non-volatile memory 164 and data stored in the non-volatile memory 164 constitute firmware executed by the processing unit 162, and the controller 160 is configured to control the flash memory 180 based on the firmware. The program code sand parameters are arranged to be loaded on the random access memory (RAM)166 to provide the controller 160. The flash memory 180 includes a plurality of blocks, each of the blocks includes a plurality of pages P0˜PN, wherein each of the pages P0˜PN has a spare area SPA0˜SPAN, as shown in FIG. 2. It should be noted that the minimum erase unit of the flash memory 180 is a block, and the minimum write unit of the flash memory 180 is a page. Moreover, the spare areas SPA0˜SPAN can be arranged at the front or end (beginning or end) of the pages, but it is not limited thereto. In other embodiments, the spare areas SPA0˜SPAN also can be arranged at the front or end of the blocks B0˜BN. It should be noted that, in one of the embodiments, each of the spare areas of the pages with valid data includes a logical address and a write sequence number. The flash memory 180 further includes a data mapping table TB1 arranged to record the mapping relationships of the logical addresses and physical addresses of all of the pages and the of the mapping relationships of the logical addresses and physical addresses of all of the blocks in the flash memory 180.

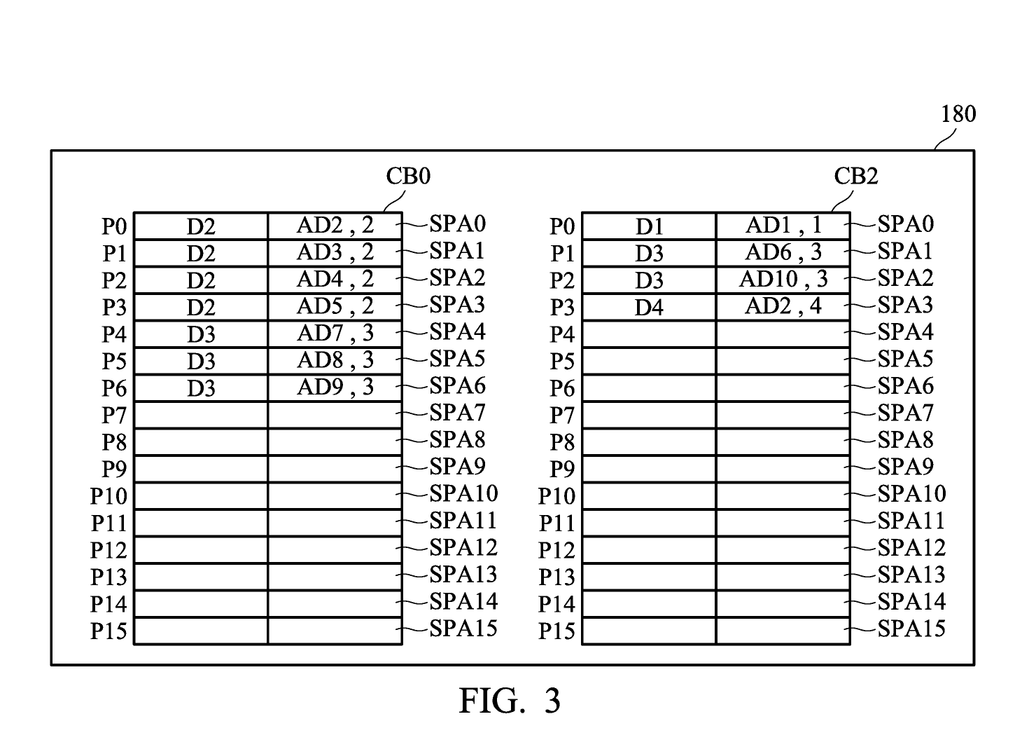

In one of the embodiments, the controller 160 receives write commands in sequence, and assigns the write sequence numbers to the write commands according to the order that the write commands are received. Moreover, the controller 160 further writes the write sequence number of the write command currently been performed and data into the page(s) of a first current block CB0 or a second current block CB1 of the blocks in response to the write commands. In one embodiments, the controller 160 determines the data that is indicated to be written by the write commands is sequential data or random data according to the write command, wherein the controller 160 further writes the sequential data into the pages of the first current block CB0 and writes the random data into the pages of the second current block CB1. For example, when the quantity of the data that is indicated to be written by the write command is greater than the quantity of the memory space of a page, the controller 160 determines that the data that is indicated to be written by the write commands is sequential data. When the quantity of the data that is indicated to be written by the write command is less than the quantity of the memory space of a page, the controller 160 determines that the data that is indicated to be written by the write commands is random data, but it is not limited thereto. It should be noted that, when the data is sequential data and a part of the data cannot fill a page, the controller 160 determines that the part of the data belongs to random data. In another embodiment, the controller 160 further writes the logical address corresponding to the data into the page of the first current block CB0 and the page of the second current block CB1. More specifically, in the process of data writing, the controller 160 selects two available blocks from the blocks B0˜BN of the flash memory 180, serves the selected two blocks as a first current block CB0 and a second current block CB1, and builds a physical-logical mapping table in the random access memory 166 to record the mapping relationships of the physical addresses and the logical address of the pages in the first current block CB0 and the second current block CB1, as shown in FIG. 3. The first current block CB0 is arranged to store the sequential data, and the second current block CB1 is arranged to store the random data. When the first current block CB0 and the second current block CB1 are filled, the controller 160 integrates the physical-logical mapping table into the data mapping table TB1, defines the first current block CB0 and the second current block CB1 as mother blocks (data blocks), selects two available blocks from the blocks B0˜BN of the flash memory 180 again, serves a new selected two blocks as the new first current block CB0 and a new second current block CB1, and builds a new physical-logical mapping table in the random access memory 166 to record the mapping relationships of the physical addresses and the logical address of the pages in the new first current block CB0 and the new second current block CB1.

FIG. 3 is a schematic diagram illustrating a current block, constructed in accordance with an embodiment. In one of the embodiments, each of the blocks B0˜BN of the flash memory 180 includes 16 number of pages P0˜P15, each of the pages P0˜P15 has a spare area (SPA0˜SPA15), but it is not limited thereto. Therefore, each of the first current block CB0 and the second current block CB1 selected by the controller 160 includes 16 number of pages P0˜P15 and 16 number of spare areas SPA0˜SPA15.

For example, when the controller 160 receives a first write command arranged to write first data D1, the controller 160 assigns a first write sequence number to the first write command according to the sequence that the write commands are received. For example, when no write commands are received before the first write command after the controller 160 selects the first current block CB0 and second current block CB1, the controller 160 assigns“1” to the first write command as the write sequence number of the first write command. It should be noted that, the first write command includes the logical address AD1 of the first data D1. The quantity of the first data D1 indicated to be written by the first write command is equal to the quantity of a page, such that the controller 160 determines that the first data D1 belongs to random data. Next, the controller 160 writes the first data D1, the first write sequence number “1” and the logical address AD1 into the page P0 of the second current block CB1. Lastly, the controller 160 records the mapping relationship of the physical address of the page P0 of the second current block CB1 and the logical address AD1 in the physical-logical mapping table.

Next, the controller 160 receives a second write command arranged to write second data D2. The controller 160 assigns a second write sequence number to the second write command according to the sequence that the second write command is received. The second write command is received after the first write command, such that the controller 160 assigns “2” as the write sequence number of the second write command. It should be noted that, the second write command includes the logical addresses AD2˜AD5 of the second data D2. The quantity of the second data D2 indicated to be written by the second write command is greater than the quantity of a page, such that the controller 160 determines that the first data D1 belongs to sequential data. Next, the controller 160 writes the second data D2, the second write sequence number “2” and the logical addresses AD2˜AD5 into the pages P0˜P3 of the first current block CB0, respectively. More specifically, the controller 160 writes the first part of the second data D2, the second write sequence number “2” and the logical address AD2 into the page P0 of the first current block CB0; writes the second part of the second data D2, the second write sequence number “2” and the logical address AD3 into the page P1 of the first current block CB0; writes the third part of the second data D2, the second write sequence number “2” and the logical address AD4 into the page P2 of the first current block CB0, and so on. Lastly, the controller 160 records the mapping relationships of the logical addresses AD2˜AD5 and the physical addresses of the pages P0˜P3 of the first current block CB0 in the physical-logical mapping table.

Next, the controller 160 receives a third write command arranged to write third data D3. The controller 160 assigns a third write sequence number to the third write command according to the sequence that the third write command is received. The third write command is received after the second write command, such that the controller 160 assigns “3” to the third write command to serve as the write sequence number of the third write command. It should be noted that, the third write command includes the logical addresses AD6˜AD10 of the third data D3. The quantity of the third data D3 indicated to be written by the third write command is greater than the quantity of a page. However, the first part and the last part of the third data D3 are less than a page, such that the first part and the last part of the third D3 are random data, and the other parts of the third data D3 are sequential data. For example, the quantity of each of the pages P0˜P15 is 16K, wherein the address of the first page is 0˜15K, the address of the second page is 16˜32K, and so on. When the logical address AD6 of the start address of the third data D3 is 8K, the first part of the third data D3 is arranged to be stored in the address of 8˜15K, such that the first part of the third data D3 is less than the quantity of a page, and the first part corresponding to the logical address AD6 of the third data D3 is random data. Next, the controller 160 defines the first part and the last part of the third data D3 as the random data, respectively writes the third write sequence number “3” and the logical addresses AD6 and AD10 into the page P1 and the page P2 of the second current block CB1, and respectively writes the other parts of the third data D3 that is defined as the sequential data, the third write sequence number “3” and the logical addresses AD7˜AD9 into the pages P4˜P6 of the first current block CB0. More specifically, the controller 160 writes the first part of the third data D3, the third write sequence number “3” and the logical address AD6 into the page P1 of the second current block CB1; writes the second part of the third data D3, the third write sequence number “3” and the logical address AD7 into the page P4 of the first current block CB0; writes the third part of the third data D3, the third write sequence number “3” and the logical address AD8 into the page P5 of the first current block CB0, and so on. Lastly, the controller 160 records the mapping relationships of the logical addresses AD6˜AD9 and the physical addresses of the pages of the first current block CB0 and the second current block CB1 in the physical-logical mapping table.

When the controller 160 receives a fourth write command arranged to write fourth data D4, the controller 160 assigns a fourth write sequence number to the fourth write command according to the sequence that the fourth write command is received. The fourth write command is received subsequent to the third write command, such that the controller 160 assigns “4” as the write sequence number of the fourth write command. It should be noted that the fourth write command includes the logical address AD2 of the fourth data. The quantity of the fourth data of the fourth write command is less than the quantity of a page, such that the controller 160 determines that the fourth data D4 belongs to random data. Next, the controller 160 writes the fourth data D4, the fourth write sequence number “4” and the logical address AD2 into the page P3 of the second current block CB1. Lastly, the logical address AD2 of the fourth data D4 is same as the logical address AD2 of the second data D2 stored in the page P0 of the first current block CB0. Therefore, after writing the fourth data D4, the controller 160 updates the physical address corresponding to the logical address AD2 by the page P3 of the second current block CB1 in the physical-logical mapping table. As described above, each of the pages with the valid data includes data, a write sequence number, and a logical address of the data. Moreover, in the present invention, the controller 160 can use the write sequence numbers of the write sequence in the data maintenance of the flash memory 180.

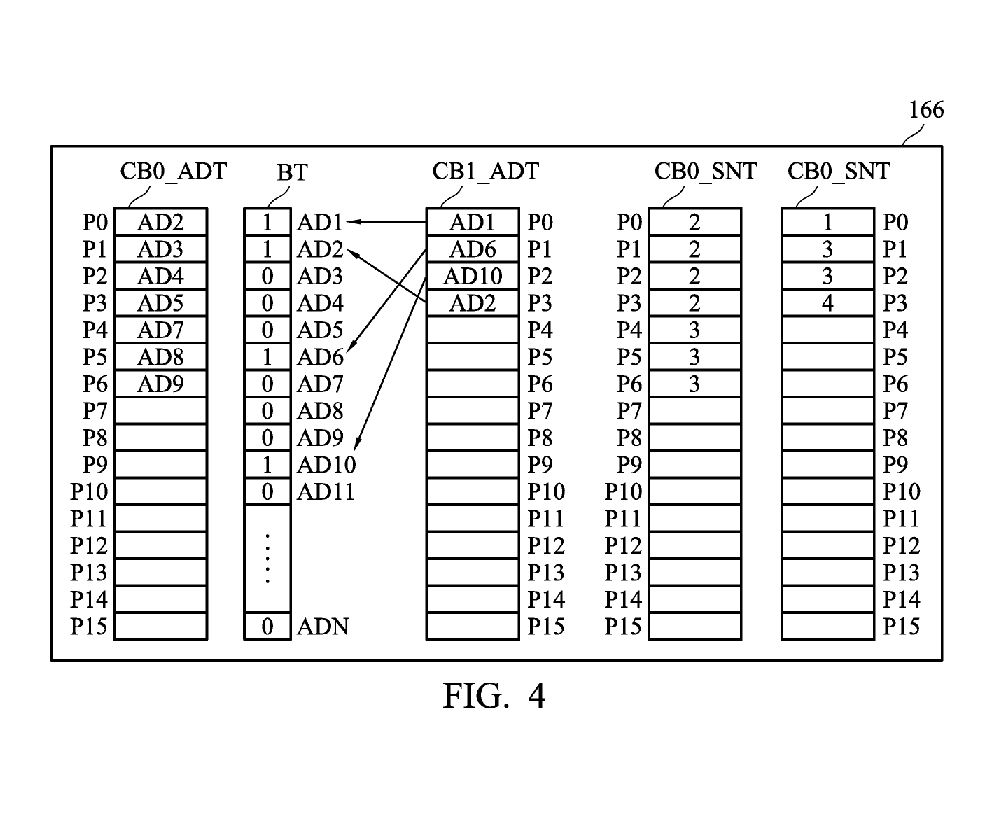

When data storage device 140 is power off, the random access memory 166 loses the physical-logical mapping table. Therefore, the controller 160 have to retrieve the data from the pages of the first current block CB0 and the second current block CB1 in sequence to rebuild the physical-logical mapping table in the random access memory 166 when the data storage device 140 is resumed from a power-off state. In one of the embodiments, the controller 166 builds a first current block table CB0_ADT and a second current block table CB1_ADT in the random access memory 166 first and organizes the first current block table CB0_ADT and the second current block table CB1_ADT according to a bit table BT to rebuild the physical-logical mapping table in the random access memory 166, as shown in FIG. 4.

More specifically, when the data storage device 140 is resumed from a power-off state, the controller 160 reads the pages of the first current block CB0 and the second current block CB1 from the flash memory 180 in sequence to build the first current block table CB0_ADT, the second current block table CB1_ADT, a first sequence number table CB0_SNT and a second sequence number table CB1_SNT. In one of the embodiments, the first current block table CB0_ADT has the logical addresses of the pages stored in the first current block CB0, and the second current block table CB1_ADT has the logical addresses of the pages stored in the second current block CB1. The first sequence number table CB0_SNT has the write sequence numbers stored in the pages of the first current block CB0, and the second sequence number table CB1_SNT has the write sequence numbers stored in the pages of the second current block CB1. It should be noted, in some of the embodiments, the first sequence number table CB0_SNT can be implemented in the first current block table CB0_ADT and the second sequence number table CB1_SNT can be implemented in the second current block table CB1_ADT, but it is not limited thereto.

Next, the controller 160 builds a bit table BT according to the logical addresses of the pages in the second current block CB1. In one embodiment, the bit table BT has a plurality of bits, the bits represent the logical addresses in sequence, but it is not limited thereto. The bit table BT can records the mapping relationships of the logical addresses in other ways. When the controller 160 reads the page from the second current block CB1, the controller 160 writes a predetermined value in the bit of the bit table BT corresponding to the logical address of the page that is read from the second current block CB1. For example, the predetermined value can be “1”, but it is not limited thereto. In other embodiments, the predetermined value can be “0” or other values.

The controller 160 further organizes the first current block table CB0_ADT and the second current block table CB1_ADT according to the bit table BT. More specifically, the controller 160 determines whether any of the logical addresses is in both of the first current block table CB0_ADT and the second current block table CB1_ADT according to the bit table BT to abandon the page(s) which is(are) in both of the tables except for the one that has the largest write sequence number in order to keep the newest page only. For example, when the controller 160 is reading a first logical address corresponding to a first page from the first current block table CB0_ADT, the controller 160 determines whether the first logical address is also in the second current block table CB1_ADT according to whether the bits of the bit table BT corresponding to the first logical address is equal to the predetermined value.

When the bit corresponding to the first logical address is equal to the predetermined value, the controller 160 determines that the first logical address has duplicate in the second current block table CB1_ADT. When the controller 160 determines that the first logical address is also in the second current block table CB1_ADT, the controller 160 reads the second current block table CB1_ADT to obtain at least one second page having the first logical address. As shown in FIG. 3, the pages of the first current block CB0 and the second current block CB1 have a plurality of write sequence numbers, each of the pages of the first current block CB0 and the second current block CB1 has a write sequence number representing the write sequence of the corresponding page. It should be noted that the page without the write sequence number and the logical address does not have valid data. After the controller 160 finds the second page with the first logical address, the controller 160 compares the write sequence numbers of the first page and the second page according the first sequence number table CB0_SNT and the second sequence number table CB1_SNT, and abandons the first page and the second page(s) except for the page with the largest write sequence number than the others in order to keep the newest page of the pages with the same logical address.

When the bit representing the first logical address is not equal to the predetermined value, the controller 160 determines that the first logical address is not in any page of the second current block table CB1_ADT. When the controller 160 determines that the first logical address is not in the second current block table CB1_ADT, the controller 160 reads the logical address of the next page from the first current block table CB0_ADT.

FIG. 4 is a schematic diagram illustrating a current block table and a bit table, constructed in accordance with an embodiment. It should be noted that FIG. 4 is based on the first current block CB0 and the second current block CB1 of FIG. 3 for an example, but it is not limited thereto. More specifically, when the data storage device 140 is resumed from the power-off state, the controller 160 reads the pages of the first current block CB0, as shown in FIG. 3, form the flash memory 180 in sequence, writes the logical addresses stored in the spare areas SPA0˜SPA15 of the first current block CB0 into the columns of the corresponding pages in the first current block table CB0_ADT, and writes the write sequence number stored in the spare areas SPA0˜SPA15 of the first current block CB0 into the columns of the corresponding pages in the first sequence number table CB0_SNT. Next, the controller 160 reads the second current block CB1, as shown in FIG. 3, from the flash memory 180 in sequence, writes the logical addresses stored in the spare areas SPA0˜SPA15 of the second current block CB1 into the columns of the corresponding pages of the second current block table CB1_ADT, writes the write sequence numbers stored in the spare areas SPA0˜SPA15 of the second current block CB1 into the columns of the corresponding pages of the second sequence number table CB1_SNT, and writes the predetermined value into the bit of the bit table BT corresponding to the read logical address according to the logical address read from the second current block CB1. More specifically, the bit table BT has a plurality of bits, the bits sequentially represents all of the logical addresses AD1˜AND of the flash memory 180. Namely, the bit table BT includes the bits corresponding to the logical addresses that can be used by the host 120, and the bit table BT includes the bits corresponding to the logical addresses stored in all the blocks of the flash memory 180. It should be noted that, in the embodiment of FIG. 3 and FIG. 4, each of the blocks has 16 pages, but it is not limited thereto. In other embodiments, each of the blocks may have 265 pages, 1036 pages, etc. Moreover, in this embodiment, the predetermined value is 1. Therefore, the controller 160 writes the predetermined value “1” into the bits of the bit table BT corresponding to the logical addresses AD1, AD6, AD10 and AD2 contained in the second current block CB1. The other bits of the bit table BT corresponding to the other logical addresses that are not in the second current block CB1 remain “0”.

Next, the controller 160 reads the logical addresses in the first current block table CB0_ADT in sequence, and determines whether any of the logical addresses is in both of the first current block table CB0_ADT and the second current block table CB1_ADT according to the bit table BT, and abandons the data stored in the pages with the same logical addresses except for the newest one. For example, when the controller 160 reads the logical address AD2 of the page P0 from the first current block table CB0_ADT, the controller 160 determines whether the bit representing the logical address AD2 in the bit table BT is equal to the predetermined value “1”. In this embodiment, the bit representing the logical address AD2 in the bit table BT is “1”, such that the controller 160 determines that the logical address AD2 is also contained in the second current block table CB1_ADT. Namely, the data D2 corresponding to the logical address AD2 in the first current block CB0 is also written in the second current block CB1. Therefore, the controller 160 has to find the page that is also corresponding to the logical address AD2 in the second current block CB1, and determine which of the pages with the logical address AD2 is the last written in the data storage device to keep the last written page and abandon the other pages. More specifically, when the controller 160 obtains that the logical address AD2 is also in the second current block table CB1_ADT according to the bit table BT, the controller 160 reads the columns of the second current block table CB1_ADT one by one to search the logical address AD2. When the controller 160 reads the page P3 corresponding to the second current block CB1, the controller 160 obtains the logical address AD2. Therefore, the controller 160 determines that the page with the same logical address in the second current block CB1 is the page P3. Next, the controller 160 reads the column corresponding to the page P0 of the first current block CB0 from the first sequence number table CB0_SNT to obtain the write sequence number “2” of the page P0 of the first current block CB0, and reads the column corresponding to the page P3 of the second current block CB1 from the second sequence number table CB1_SNT to obtain the write sequence number “4” of the page P3 of the second current block CB1. Next, the controller 160 compares the write sequence number “2” of the page P0 of the first current block CB0 with the write sequence number “4” of the page P3 of the second current block CB1, and determines that page P3 of the second current block CB1 with the larger write sequence number “4” is written after the page P0 of the first current block CB0. Therefore, the controller 160 keeps the data of the page P3 of the second current block table CB1_ADT, and invalidates the data of the page P0 of the first current block table CB0_ADT.

Next, when the controller 160 reads the logical address AD3 corresponding to the page P1 from the first current block table CB0_ADT, the controller 160 determines whether the bit representing the logical address AD3 in the bit table BT is equal to the predetermined value “1”. In this embodiment, the bit representing the logical address AD3 in the bit table BT is “0”, such that the controller 160 determines that the second current block table CB1_ADT does not have the logical address AD3. Namely, the data D2 of the logical address AD3 in the first current block CB0 is not repeatedly written into the second current block CB1, and so on, until the controller 160 processed all of the data in the first current block table CB0_ADT by the above steps.

As described above, the controller 160 can identify the write sequence of the data with the same logical address in the current blocks according to the write sequence numbers and the bit table BT to organize the first current block table CB0_ADT and the second current block table CB1_ADT to rebuild the physical-logical mapping table. Namely, the controller 160 will not record the old data in the physical-logical mapping table.

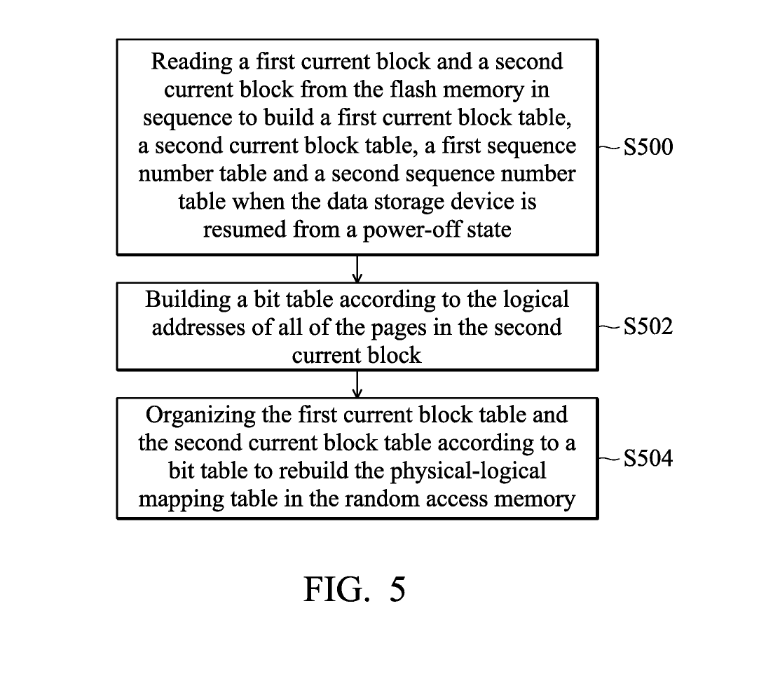

FIG. 5 is a flowchart of a data maintenance method constructed in accordance with some embodiments. The data maintenance method is applied to the data storage device 140 of FIG. 1, and arranged to rebuild the physical-logical mapping table when the data storage device 140 is resumed from a power-off state. The process starts at step S500.

In step S500, when the data storage device 140 is resumed from a power-off state, the controller 160 reads a first current block CB0 and a second current block CB1 from the flash memory 180 in sequence to build a first current block table CB0_ADT, a second current block table CB1_ADT, a first sequence number table CB0_SNT and a second sequence number table CB1_SNT. In one of the embodiments, the first current block table CB0_ADT has the logical addresses of the pages stored in the first current block CB0, and the second current block table CB1_ADT has the logical addresses of the pages stored in the second current block CB1. The first sequence number table CB0_SNT has the write sequence numbers stored in the pages of the first current block CB0, and the second sequence number table CB1_SNT has the write sequence numbers stored in the pages of the second current block CB1. It should be noted, in some of the embodiments, the first sequence number table CB0_SNT can be implemented in the first current block table CB0_ADT and the second sequence number table CB1_SNT can be implemented in the second current block table CB1_ADT, but it is not limited thereto. For example, as shown in FIG. 3 and FIG. 4, when the data storage device 140 is resumed from the power-off state, the controller 160 reads the pages of the first current block CB0, as shown in FIG. 3, form the flash memory 180 in sequence, writes the logical addresses stored in the spare areas SPA0˜SPA15 of the first current block CB0 into the columns of the corresponding pages in the first current block table CB0_ADT, and writes the write sequence number stored in the spare areas SPA0˜SPA15 of the first current block CB0 into the columns of the corresponding pages in the first sequence number table CB0_SNT. Next, the controller 160 reads the second current block CB1, as shown in FIG. 3, from the flash memory 180 in sequence, writes the logical addresses stored in the spare areas SPA0˜SPA15 of the second current block CB1 into the columns of the corresponding pages of the second current block table CB1_ADT, and writes the write sequence numbers stored in the spare areas SPA0˜SPA15 of the second current block CB1 into the columns of the corresponding pages of the second sequence number table CB1_SNT.

Next, in step S502, the controller 160 builds a bit table BT according to the logical addresses of all of the pages in the second current block CB1. More specifically, in one of the embodiments, the bit table BT has a plurality of bits, the bits represents the logical addresses in sequence, but it is not limited thereto. The bit table BT can records the mapping relationships of the logical addresses in other ways. When the controller 160 reads the page of the second current block CB1, the controller 160 writes a predetermined value in the bit of the bit table BT corresponding to the logical address of the page that is reading from the second current block CB1. For example, the predetermined value can be “1”, but it is not limited thereto. In other embodiments, the predetermined value can be “0” or other values. For an example, as shown in FIG. 3 and FIG. 4, the predetermined value is “1”. Therefore, the controller 160 writes the predetermined value “1” into the bits of the bit table BT corresponding to the logical addresses AD1, AD6, AD10 and AD2 contained in the second current block CB1. The other bits of the bit table BT corresponding to the other logical addresses that are not in the second current block CB1 remain “0”.

Next, in step S504, the controller 160 organizes the first current block table CB0_ADT and the second current block table CB1_ADT according to a bit table BT to rebuild the physical-logical mapping table in the random access memory 166. It should be noted that, in this embodiment, the first current block table CB0_ADT, the second current block table CB1_ADT, the first sequence number table CB0_SNT, the second sequence number table CB1_SNT, the bit table BT and the physical-logical mapping table are all implemented in the random access memory 166.

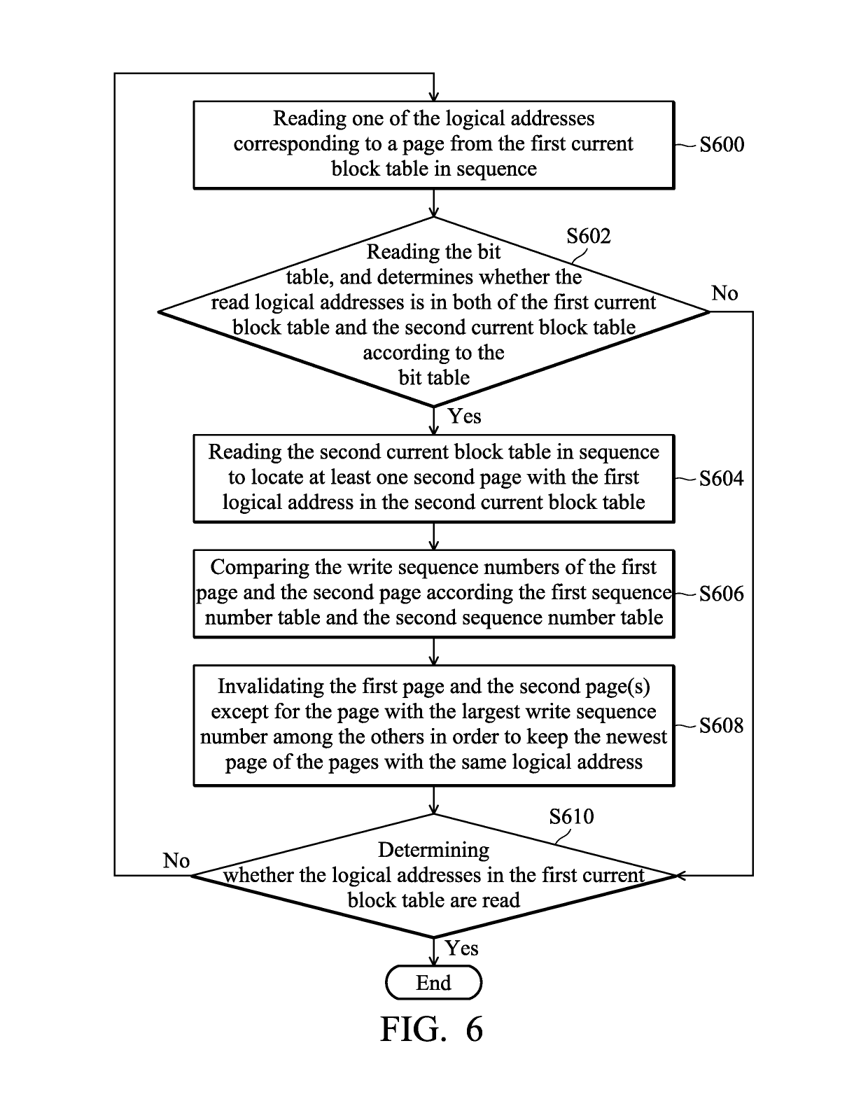

FIG. 6 is a flowchart of a method for organizing a current block table constructed in accordance with some embodiments. The method for organizing a current block table is applied to the data storage device 140 of FIG. 1, wherein the method for organizing a current block table is an embodiment of the step S504 of FIG. 5. The process starts at step S600.

In step S600, the controller 160 reads one of the logical addresses corresponding to a page from the first current block table CB0_ADT in sequence.

Next, in step S602, the controller 160 reads the bit table BT, and determines whether the read logical addresses is in both of the first current block table CB0_ADT and the second current block table CB1_ADT according to the bit table BT. More specifically, when the controller 160 is reading a first logical address corresponding to a first page from the first current block table CB0_ADT in step S600, the controller 160 determines whether the first logical address is also in the second current block table CB1_ADT according to whether the bits of the bit table BT corresponding to the first logical address is equal to the predetermined value. When the bit corresponding to the first logical address is equal to the predetermined value, the controller 160 determines that the first logical address has duplicate in the second current block table CB1_ADT, and the process goes to step S604. When the bit representing the first logical address is not equal to the predetermined value, the controller 160 determines that the first logical address is not in any page of the second current block table CB1_ADT, and the process goes to step S610.

In step S604, the controller 160 reads the second current block table CB1_ADT in sequence to locate at least one second page with the first logical address in the second current block table CB1_ADT.

Next, in step S606, the controller 160 compares the write sequence numbers of the first page and the second page according the first sequence number table CB0_SNT and the second sequence number table CB1_SNT.

Next, in step S608, the controller 160 invalidates the first page and the second page(s) except for the page with the largest write sequence number among the others in order to keep the newest page of the pages with the same logical address.

Next, in step S610, the controller 160 determines whether the logical addresses in the first current block table CB0_ADT are read. When all of the logical addresses in the first current block table CB0_ADT are read, the process ends at step S610. When at least one of the logical addresses in the first current block table CB0_ADT has not been read, the process returns to step S600 to continue to read the logical address of the next page in the first current block table CB0_ADT.

The data storage device 140 and the data maintenance method of the present invention can determine whether the logical addresses are in both of the two tables to decrease the rebuild time of the physical-logical mapping table.

Data transmission methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, comprising a plurality of blocks, each of the blocks has a plurality of pages, wherein the flash memory stores data of a plurality of logical addresses; and
a controller, reading a first current block and a second current block from the flash memory in sequence to build a first current block table and a second current block table and building a bit table according to the logical addresses of the pages of the second current block when the data storage device is resumed from a power-off state, wherein the controller further organizes the first current block table and the second current block table according to the bit table.

2. The data storage device as claimed in claim 1, wherein the bit table has a plurality of bits, each of the bits of the bit table corresponds sequentially to the logical addresses, the first current block table has the logical addresses stored in the pages of the first current block and the second current block table has the logical addresses stored in the pages of the second current block, wherein when the controller reads a page of the second current block, the controller writes a predetermined value in the bit corresponding to the logical address of the read page of the second current block.

3. The data storage device as claimed in claim 2, wherein the controller determines whether any of the logical addresses are stored in both of the first current block table and the second current block table according to the bit table.

4. The data storage device as claimed in claim 2, wherein the controller determines whether the first logical address is in both of the first current block table and the second current block table according to whether the bit corresponding to a first logical address in the bit table is equal to predetermined value when retrieving the first logical address of a first page from the first current block table, wherein the controller determines that the first logical address is in both of the first current block table and the second current block table when the bit corresponding to the first logical address is equal to the predetermined value, and the controller determines that the first logical address is not in the second current block table when the bit of the first logical address is not equal to the predetermined value.

5. The data storage device as claimed in claim 4, wherein the controller reads the second current block table to obtain at least one second page having the first logical address when the controller determines that the first logical address is in both of the first current block table and the second current block table, and the controller read the logical address stored in the next page of the first current block table when the controller determines that the first logical address is not in the second current block table.

6. The data storage device as claimed in claim 5, wherein each of the pages of the first current block and the second current block has a write sequence number that represents the sequence that the corresponding page is written.

7. The data storage device as claimed in claim 6, wherein after obtaining the second page having the first logical address, the controller compares the write sequence number of the first page with the write sequence number of the second page and abandons at least one of the first page and the at least one second page except for the one that has the largest write sequence number of the first page and the at least one second page.

8. The data storage device as claimed in claim 7, wherein the controller further compares the write sequence numbers of the first page and the second page according to a first sequence number table and a second sequence number table, wherein the first sequence number table comprises the write sequence numbers stored in the pages of the first current block, and the second sequence number table comprises the write sequence numbers stored in the pages of the second current block

9. The data storage device as claimed in claim 1, wherein the controller writes sequential data into the pages of the first current block and writes random data into the pages of the second current block in response to write commands.

10. A data maintenance method, applied to a data storage device of a flash memory, wherein the flash memory comprises a plurality of blocks, each of the blocks comprises a plurality of page, and the flash memory stores data of a plurality of logical addresses, the data maintenance method comprising:
reading a first current block and a second current block from the flash memory in sequence to build a first current block table and a second current block table and building a bit table according to the logical addresses of the pages of the second current block when the data storage device is resumed from a power-off state; and
organizing the first current block table and the second current block table according to the bit table.

11. The data maintenance method as claimed in claim 10, wherein the bit table has a plurality of bits, each of the bits of the bit table corresponds sequentially to the logical addresses, the first current block table has the logical addresses stored in the pages of the first current block, and the second current block table has the logical addresses stored in the pages of the second current block, wherein the step of building the bit table according to the logical addresses of the pages of the second current block further comprises when a page of the second current block is read, writing a predetermined value into the bit corresponding to the logical address of the read page of the second current block.

12. The data maintenance method as claimed in claim 11, wherein the step of organizing the first current block table and the second current block table according to the bit table further comprises determining whether any of the logical addresses are stored in both of the first current block table and the second current block table according to the bit table.

13. The data maintenance method as claimed in claim 12, wherein the step of organizing the first current block table and the second current block table according to the bit table further comprises:
determining whether the first logical address is in both of the first current block table and the second current block table according to whether the bit corresponding to a first logical address in the bit table is equal to predetermined value when retrieving the first logical address of a first page from the first current block table;
determining that the first logical address is in both of the first current block table and the second current block table when the bit corresponding to the first logical address is equal to the predetermined value; and
determining that the first logical address is not in the second current block table when the bit of the first logical address is not equal to the predetermined value.

14. The data maintenance method as claimed in claim 13, wherein the step of organizing the first current block table and the second current block table according to the bit table further comprises:
reading the second current block table to obtain at least one second page having the first logical address when the first logical address is in both of the first current block table and the second current block table; and
reading the logical address stored in the next page of the first current block table when the first logical address is not in the second current block table.

15. The data maintenance method as claimed in claim 14, wherein each of the pages of the first current block and the second current block has a write sequence number that represents the sequence that the corresponding page is written.

16. The data maintenance method as claimed in claim 15, wherein the step of organizing the first current block table and the second current block table according to the bit table further comprises:
after obtaining the second page having the first logical address, comparing the write sequence number of the first page with the write sequence number of the second page; and
abandoning at least one of the first page and the at least one second page except for the one that has the largest write sequence number of the first page and the at least one second page.

17. The data maintenance method as claimed in claim 16, wherein the step of comparing the write sequence number of the first page with the write sequence number of the second page further comprises comparing the write sequence numbers of the first page and the second page according to a first sequence number table and a second sequence number table, wherein the first sequence number table comprises the write sequence numbers stored in the pages of the first current block, and the second sequence number table comprises the write sequence numbers stored in the pages of the second current block.

18. The data maintenance method as claimed in claim 10, further comprising writing sequential data into the pages of the first current block and writes random data into the pages of the second current block in response to write commands.
